(19) United States
(12) Patent Application Publication
(10) Pub. No.: US 2008/0284578 A1
(43) Pub. Date: Nov. 20, 2008

(54) Automobile communication device

(76) Inventor: Evdokimos Mouratidis, Stratford, NJ (US)

Correspondence Address: JAMES RAY & ASSOCIATES, 2640 Pitcairn Road, Monroeville, PA, 15146, US

(21) Appl. No.: 12/152,699

(22) Filed: May 16, 2008

Related U.S. Application Data
(60) Provisional application No. 60/938,210, filed on May 16, 2007.

(51) Int. Cl. B60Q 1/26; G08B 5/22

(52) U.S. Cl. 340/468; 340/485

(57) ABSTRACT

An automobile communication device includes a housing operably connectable to an automobile and having a rearward facing transparent portion. A display mechanism having sides each with predetermined indicia thereon is rotatably disposed within such housing. A motor is operably connected to the display mechanism for rotating the display mechanism. A power source is operably connected to the motor. A switch mechanism is operably connected to the power source. A control mechanism is operably connected to at least one of the display mechanism, such automobile, the power source, the motor, the switch mechanism, and a combination thereof for enabling a user to select a predetermined side of the display mechanism for being at least one of rearward facing and visible through such portion. A stop mechanism is operably connected to at least one of the display mechanism, the housing, and a combination thereof for stopping the display mechanism from rotating.

### CROSS REFERENCE TO RELATED APPLICATION

This patent application is related to and claims priority from U.S. Provisional Patent Application Ser. No. 60/938,210 filed May 16, 2007.

### FIELD OF THE INVENTION

The present invention relates, in general, to communication devices and, more particularly, this invention relates to a lighted communication device for attachment to an automobile.

### BACKGROUND OF THE INVENTION

Prior to the conception and development of the present invention, automobile communication devices, as are generally well known in the prior art, have been used to convey messages to other drivers and pedestrians. For example, turn signals are used to inform others that a vehicle is about to turn left or right. Brake lights indicate that a vehicle is slowing or stopping. The beeping of a horn is used to alert others to a particular situation such as oncoming traffic, people or animals in the roadway, accidents, dangerous situations, the change of a light from red to green, and many other situations. Unfortunately, drivers are often distracted by music, cell phones, text messages, other passengers, etc. and they often misunderstand or fail to observe what their fellow drivers are attempting to communicate. Therefore, devices which enhance communication between automobile drivers, pedestrians, and the like are very desirable.

Specifically of interest to the present invention are the following: Hose, U.S. Pat. No. 4,361,828 discloses a vehicle communication system consisting of an opto-electrical message display unit adapted to be viewed from the exterior of the vehicle and of a message control unit that is connected to the display unit for programming a message and transmitting an electrical pulse pattern to the display unit that causes the display unit to display the programmed message.

Burgan, et al, U.S. Pat. No. 3,750,138 discloses a visual display system for simultaneously displaying the individual characters of a word unit. A plurality of messages may be individually displayed. The device is meant to enable law enforcement officers to communicate with vehicle occupants and pedestrians.

Lev, U.S. Pat. No. 3,678,457, discloses a visual signal indicator having a light unit mountable at the rear of the vehicle which contains a plurality of separate light source chambers, upon each chamber being lit, at least one message is displayed.

Newman, et al, U.S. Pat. No. 3,226,707, discloses a message indicator including a housing having a window portion and a tape adapted for rotational movement within such housing. The tape has messages printed thereon for display through such window.

Miller, U.S. Pat. No. 4,574,269, discloses a visual communicator for a rear window of a vehicle. The communicator is semi-transparent and adapted to be disposed in the rear window of the vehicle for viewing from outside of the vehicle. The communicator includes a message display unit including a plurality of light emitting diodes in a matrix arrangement. The light emitting diodes are selectively energizable to emit light in the form of a message.

Owens, U.S. Pat. No. 2,968,025, discloses a highway patrol car rotary signal including a housing having an indicia bearing polygonal drum therein and a motor for rotating the drum.

Zgraggen, U.S. Pat. No. 2,843,952 discloses a visual signaling system including an upright cubical housing including a window and an indicia bearing wheel within such housing. The wheel is movable such that the indicia may be viewed to indicate a particular movement by the vehicle, or a blank side of such wheel may be viewed.

Wagner, U.S. Pat. No. 3,320,586, discloses an apparatus for visually signaling vehicle operating speed, acceleration, deceleration, braking, and stopping.

Tang, U.S. Publication No. 2006/109145, discloses a lighted display device for attachment to an exterior portion of a vehicle to display a particular message.

McGrouther, Publication No. GB2434908, discloses a vehicle sign for mounting externally on a vehicle for presenting a visual or audio message including raised lettering such as Braille.

### SUMMARY OF THE INVENTION

The present invention provides an automobile communication device. Such automobile communication device includes a housing member manufactured from a first predetermined material and having a first predetermined size and a first predetermined shape. The housing member has a transparent portion on a predetermined side thereof. The transparent portion has a second predetermined size and a second predetermined shape. The housing member is operably connectable to an automobile at a predetermined location thereon such that the transparent portion is rearward facing. A display means is manufactured from a second predetermined material and has a third predetermined size and a third predetermined shape. The display means has at least two sides, each of the sides has predetermined indicia thereon. The display means is rotatably disposed within the housing member such that at least one predetermined side of the display means is at least one of rearward facing and visible through the transparent portion. A motor is disposed within the housing member and is operably connected to the display means at a predetermined location thereon for rotating the display means. A power source is operably connected to the motor at a predetermined location thereon for supplying power thereto such that the motor can rotate the display means. A switch means is operably connected to the power source for selectively turning the power source on and off. A control means is operably connected to at least one of the display member, such automobile, the power source, the motor, the switch means, and a combination thereof at a predetermined location thereon for enabling a user to select a predetermined side of the display means for rotation such that the predetermined side is at least one of rearward facing and visible through the transparent portion of the housing member. A stop means is operably connected to at least one of the display means, the housing member, and a combination thereof at a predetermined location thereon for selectively stopping the display means from rotating once the selected predetermined side is at least one of rearward facing and visible through the transparent portion of the housing member.

According to another embodiment, a method of communication between a first driver of a first vehicle and at least one of at least one additional driver, at least one pedestrian, at least one passenger of at least one additional vehicle, and a combination thereof is provided. Such method includes selecting a predetermined message. Activating a control means on an automobile communication device having: a housing member having a transparent portion on a predetermined side thereof, such housing member being operably connectable to an automobile at a predetermined location thereon such that the transparent portion is rearward facing; a display means having at least two sides, each of the sides having predetermined indicia thereon, the display means being rotatably disposed within the transparent portion of the housing member such that at least one predetermined side of the display means is at least one of rearward facing and visible through the transparent portion; a motor disposed within the housing member and operably connected to the display means at a predetermined location thereon for rotating the display means; a power source operably connected to the motor at a predetermined location thereon for supplying power thereto such that the motor can rotate the display means; a switch means operably connected to the power source for selectively turning the power source on and off; a control means operably connected to at least one of the display means, such automobile, the power source, the motor, the switch means, and a combination thereof at a predetermined location thereon for enabling a user to select a predetermined side of the display means for rotation such that the predetermined side is at least one of rearward facing and visible through the transparent portion of the housing member; a stop means operably connected to at least one of the display means, the housing member, and a combination thereof at a predetermined location thereon for selectively stopping the display means from rotating once the selected predetermined side is at least one of rearward facing and visible through the transparent portion of the housing member; a lighting means operably disposed within at least one of the housing member and the display means at a predetermined location thereon and operably connected to at least one of the power source, the display means, the switch means, the control means and a combination thereof for illuminating the display means; a signal means operably connected to at least one of the control means, the display means, the housing member, the power source, the switch means, and a combination thereof at a predetermined location thereon for indicating to the control means that the selected predetermined side of the display means is rearward facing; and a timing means operably connected to at least one of the power source, the lighting means, the control means, the switch means and a combination thereof at a predetermined location thereon for automatically ending the illumination of the display means after a predetermined amount of time has passed. Rotating the display means. Illuminating the display means. Timing the illumination. De-energizing the lighting means.

### OBJECTS OF THE INVENTION

It is, therefore, one of the primary objects of the present invention to provide a device which permits an automobile driver to convey a predetermined message to another automobile driver, pedestrian or the like.

Another object of the present invention is to provide a lighted display which can be used to indicate the messages “Sorry” and “Thank you” as desired.

Still another object of the present invention is to provide a display device which includes a rotatable message display which can convey timed courtesy messages from a driver of an automobile to other drivers, pedestrians and the like, thereby generating goodwill.

Yet another object of the present invention is to provide a means to apologize to another driver for cutting him or her off, or the like, thereby reducing the other driver's angry feelings and overall reducing road rage.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention.

FIG. 3 is a partial perspective view of the invention according to one embodiment of the invention.

FIG. 4 is a partial cross-sectional view of the invention taken along the lines IV-IV of FIG. 3.

FIG. 5 is a partial perspective view of the invention according to one embodiment of the invention.

FIG. 6 is a partial perspective view of the invention according to one embodiment of the invention.

FIG. 7 is a partial schematic view of the invention according to one embodiment of the invention.

### BRIEF DESCRIPTION OF A PRESENTLY

### Preferred and Various Alternative Embodiments of the Invention

Prior to proceeding to the more detailed description of the present invention it should be noted that, for the sake of clarity and understanding, identical components which have identical functions have been identified with identical reference numerals throughout the several views illustrated in the drawing figures.

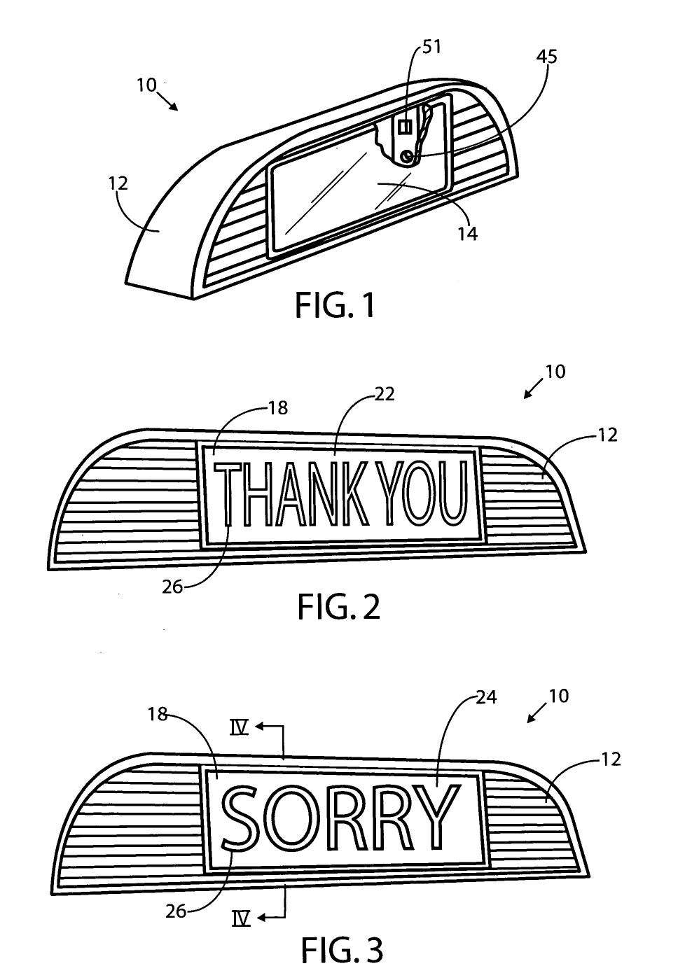

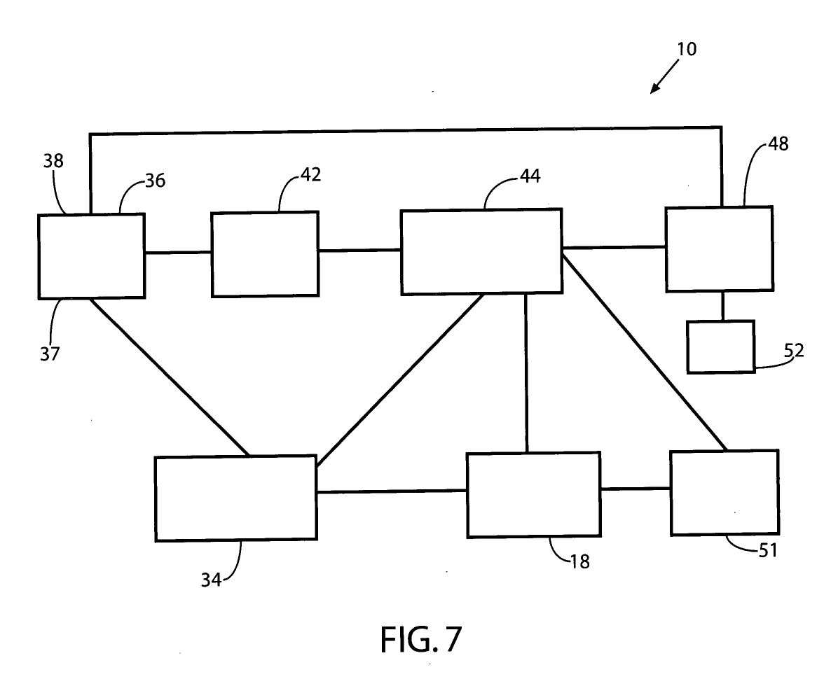

Reference is now made, more particularly, to FIGS. 1-7.

An automobile communication device, generally designated 10, is provided. Such automobile communication device 10 includes a housing member 12 manufactured from a first predetermined material and having a first predetermined size and a first predetermined shape. It is presently preferred that such housing member 12 is at least one of weather resistant, waterproof, and water tight.

The housing member 12 has a transparent portion 14 on a predetermined side thereof. The transparent portion 14 has a second predetermined size and a second predetermined shape. The housing member 12 is operably connectable to an automobile 16 at a predetermined location thereon such that the transparent portion 14 is rearward facing.

The housing member 12 is particularly well suited to being attachable to an automobile 16 at a location where persons behind such automobile 16 will see such housing member, for instance the housing member 12 may be placed on the outside of the automobile, integrated into the design of the automobile on an outside thereof, or placed on the inside of the automobile closely adjacent a rear window thereof. The device 10 may be integrated into the design of such automobile 16, for example integrated into a brake light portion of a vehicle. The housing member 12 is operably connectable to such automobile 16 and can be secured thereto by any securing means desirable.

A display means 18 is manufactured from a second predetermined material and has a third predetermined size and a third predetermined shape. It is presently preferred that such display means 18 is at least one of weather resistant, waterproof, and water tight.

The display means has at least two sides, each of the sides has predetermined indicia 26 thereon. It is presently preferred that such predetermined indicia 26 includes at least one of symbols, letters, words, pictorial designs, and a combination thereof. It is presently most preferred that such predetermined indicia indicates at least one of “Thank you” and “Thanks” on a first predetermined side 22 of the display means 18 and wherein such predetermined indicia 26 indicates “Sorry” on a second predetermined side 24 of the display means 18. However, such display means 18 is not meant to be limited as such and may include a variety of messages and images. Furthermore, such display means 18 may have more than two sides thereby increasing the number of messages and the amount of indicia capable of being displayed thereon.

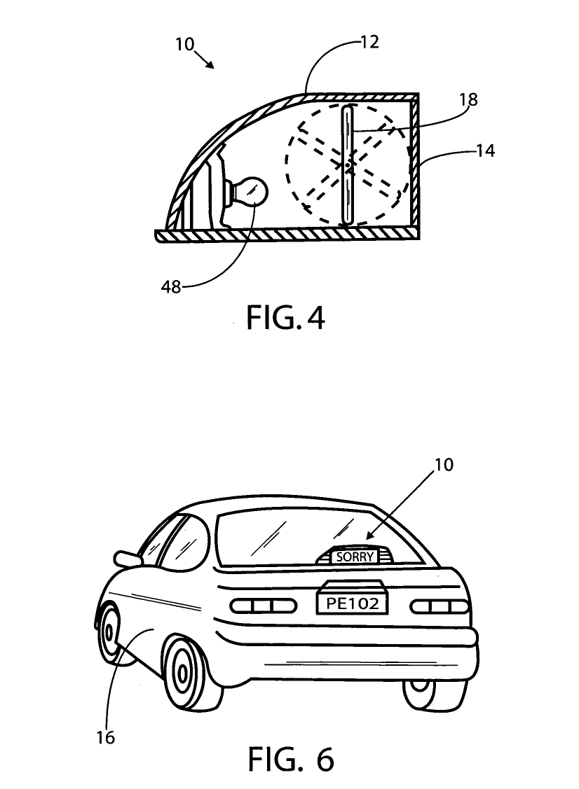

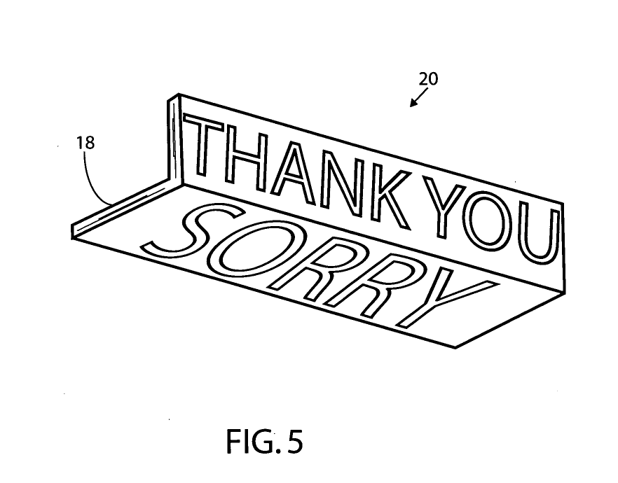

The display means 18 is rotatably disposed within the housing member 12 such that at least one predetermined side of the display means 18 is at least one of rearward facing and visible through the transparent portion 14. As illustrated in FIG. 4 the display means 18 may have an elongated rectangular shape that rotates to display the desired message. However, as illustrated in FIG. 5, according to another embodiment, generally designated 20, the display member may have an elongated L shape and may need only be rotated slightly to display the desired message.

A motor 34 is disposed within the housing member 12 and is operably connected to the display means 18 at a predetermined location thereon for rotating the display means 18.

A power source 36 is operably connected to the motor 34 at a predetermined location thereon for supplying power thereto such that the motor 34 can rotate the display means 18. It is presently preferred that such power source 36 is a battery 37. It is presently preferred that such battery 37 is rechargeable. It is presently most preferred that such battery 37 is an automobile battery 38.

A switch means 42 is operably connected to the power source 34 for selectively turning the power source 36 on and off.

A control means 44 is operably connected to at least one of the display means 18, such automobile 16, the power source 36, the motor 34, the switch means 42, and a combination thereof at a predetermined location thereon for enabling a user (not shown) to select a predetermined side of the display means 18 for rotation such that the predetermined side is at least one of rearward facing and visible through the transparent portion 14 of the housing member 12.

It is presently preferred that such control means is located on a dashboard portion of an automobile such that it is easily within reach of a driver of such automobile, another possible location would be on a steering wheel portion of an automobile or any other location where vehicle controls are located accessible to such driver. The control may be a simple push button type of control with a button for each displayable message. If such driver desires to display the message “Thank you” then such driver could simply depress a button labeled “Thank you” and so on.

A stop means 45 is operably connected to at least one of the display means 18, the housing member 12, and a combination thereof at a predetermined location thereon for selectively stopping the display means 18 from rotating once the selected predetermined side is at least one of rearward facing and visible through the transparent portion 14 of the housing member 12.

It is presently preferred that such automobile communication device 10 further includes a lighting means 48 operably disposed within at least one of the housing member 12 and the display means 18 and being operably connected to at least one of the power source 36, the display means 18, the switch means 42, the control means 44 and a combination thereof for illuminating the display means 18 from at least one of behind and within. It is presently preferred that such lighting means 48 is at least one of a fluorescent lighting means, an incandescent lighting means, and a light emitting diode lighting means. Furthermore, the indicia 26 disposed on the display means 18 may be transparent or opaque and may only be visible when the lighting means 48 illuminates the display means.

It is presently preferred that such automobile communication device 10 further includes a signal means 51 operably connected to at least one of the control means 44, the display means 18, the housing member 12, the power source 36, the switch means 42 and a combination thereof at a predetermined location thereon for indicating to the control means 44 that the selected predetermined side of the display means 18 is rearward facing. It is meant that the motor stops rotating the display means 18 once the display means is in the desired position. Such signal means 51 may be used to signal the control means 44 that the display means has reached a desired position. It is meant that then the control means 44 will control the switch means 42 such that power to the motor 34 will be terminated thereby ending rotation of the display means 18.

It is presently preferred that such automobile communication device 10 further includes a timing means 52 operably connected to at least one of the power source 36, the lighting means 48, the switch means 42, the control means 44, and a combination thereof at a predetermined location thereon for automatically ending the illumination of the display means 18 after a predetermined amount of time has passed. It is presently preferred that such predetermined amount of time is between about 3 seconds and about 8 seconds. It is presently most preferred that such predetermined amount of time is about 5 seconds.

Such timing means 52 may also be operably connected to the motor 34 and used to time the rotation of the display means 18 and end rotation after a certain amount of time has passed, for example the time required for the display means 18 to rotate from a present predetermined position to a desired position.

According to another embodiment, a method of communication between a first driver of a first vehicle and at least one of at least one additional driver, at least one pedestrian, at least one passenger of at least one additional vehicle, and a combination thereof is provided.

Such method includes selecting a predetermined message.

Activating a control means on an automobile communication device having: a housing member having a transparent portion on a predetermined side thereof, such housing member being operably connectable to an automobile at a predetermined location thereon such that the transparent portion is rearward facing; a display means having at least two sides, each of the sides having predetermined indicia thereon, the display means being rotatably disposed within the housing member such that at least one predetermined side of the display means is at least one of rearward facing and visible through the transparent portion; a motor disposed within the housing member and operably connected to the display means at a predetermined location thereon for rotating the display means; a power source operably connected to the motor at a predetermined location thereon for supplying power thereto such that the motor can rotate the display means; a switch means operably connected to the power source for selectively turning the power source on and off; a control means operably connected to at least one of the display means, such automobile, the power source, the motor, the switch means, and a combination thereof at a predetermined location thereon for enabling a user to select a predetermined side of the display means for rotation such that the predetermined side is at least one of rearward facing and visible through the transparent portion of the housing member; a stop means operably connected to at least one of the display means, the housing member, and a combination thereof at a predetermined location thereon for selectively stopping the display means from rotating once the selected predetermined side is at least one of rearward facing and visible through the transparent portion of the housing member; a lighting means operably disposed within at least one of the housing member and the display means at a predetermined location thereon and operably connected to at least one of the power source, the display means, the switch means, the control means and a combination thereof for illuminating the display means; a signal means operably connected to at least one of the control means, the display means, the housing member, the power source, the switch means and a combination thereof at a predetermined location thereon for indicating to the control means that the selected predetermined side of the display means is rearward facing; and a timing means operably connected to at least one of the power source, the lighting means, the control means, the switch means and a combination thereof at a predetermined location thereon for automatically ending the illumination of the display means after a predetermined amount of time has passed.

Rotating the display means.

Illuminating the display means.

Timing the illumination.

De-energizing the lighting means.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An automobile communication device comprising:
a. a housing member manufactured from a first predetermined material and having a first predetermined size and a first predetermined shape, said housing member having a transparent portion on a predetermined side thereof, said transparent portion having a second predetermined size and a second predetermined shape, said housing member being operably connectable to an automobile at a predetermined location thereon such that said transparent portion is rearward facing;
b. a display means manufactured from a second predetermined material and having a third predetermined size and a third predetermined shape, said display means having at least two sides, each of said sides having predetermined indicia thereon, said display means being rotatably disposed within said transparent portion of said housing member such that at least one predetermined side of said display means is at least one of rearward facing and visible through said transparent portion;
c. a motor disposed within said housing member and operably connected to said display means at a predetermined location thereon for rotating said display means;
d. a power source operably connected to said motor at a predetermined location thereon for supplying power thereto such that said motor can rotate said display means;
e. a switch means operably connected to said power source for selectively turning said power source on and off;
f. a control means operably connected to at least one of said display means, such automobile, said power source, said motor, said switch means, and a combination thereof at a predetermined location thereon for enabling a user to select a predetermined side of said display means for rotation such that said predetermined side is at least one of rearward facing and visible through said transparent portion of said housing member; and
g. a stop means operably connected to at least one of said display means, said housing member, and a combination thereof at a predetermined location thereon for selectively stopping said display means from rotating once said selected predetermined side is at least one of rearward facing and visible through said transparent portion of said housing member.

2. An automobile communication device according to claim 1 wherein said automobile communication device further includes a lighting means operably disposed within at least one of said housing member and said display means and being operably connected to at least one of said power source, said switch means, said control means, said display means and a combination thereof for illuminating said display means from at least one of behind and within.

3. An automobile communication device according to claim 1 wherein said automobile communication device further includes a signal means operably connected to at least one of said control means, said display means, said housing member the power source, the switch means and a combination thereof at a predetermined location thereon for indicating to said control means that said selected predetermined side of said display means is rearward facing.

4. An automobile communication device according to claim 2 wherein said automobile communication device further includes a timing means operably connected to at least one of said power source, said lighting means, said switch means, said control means, and a combination thereof at a predetermined location thereon for automatically ending said illumination of said display means after a predetermined amount of time has passed.

5. An automobile communication device according to claim 4 wherein said predetermined amount of time is between about 3 seconds and about 8 seconds.

6. An automobile communication device according to claim 5 wherein said predetermined amount of time is about 5 seconds.

7. An automobile communication device according to claim 1 wherein said predetermined indicia indicates at least one of “Thank you” and “Thanks” on a first predetermined side of said display means and wherein said predetermined indicia indicates “Sorry” on a second predetermined side of said display means.

8. An automobile communication device according to claim 1 wherein said predetermined indicia includes at least one of symbols, letters, words, pictorial designs, and a combination thereof.

9. An automobile communication device according to claim 1 wherein said power source is a battery.

10. An automobile communication device according to claim 9 wherein said battery is rechargeable.

11. An automobile communication device according to claim 9 wherein said battery is an automobile battery.

12. An automobile communication device according to claim 1 wherein said housing member is at least one of weather resistant, waterproof, and water tight.

13. An automobile communication device according to claim 1 wherein said display means is at least one of weather resistant, waterproof, and water tight.

14. An automobile communication device according to claim 1 wherein said lighting means is at least one of a fluorescent lighting means, an incandescent lighting means, and a light emitting diode lighting means.

15. A method of communication between a first driver of a first vehicle and at least one of at least one additional driver, at least one pedestrian, at least one passenger of at least one additional vehicle, and a combination thereof comprising the steps of:
a. selecting a predetermined message;
b. activating a control means on an automobile communication device having:
i. a housing member having a transparent portion on a predetermined side thereof, said housing member being operably connectable to an automobile at a predetermined location thereon such that said transparent portion is rearward facing;
ii. a display means having at least two sides, each of said sides having predetermined indicia thereon, said display means being rotatably disposed within said housing member such that at least one predetermined side of said display means is at least one of rearward facing and visible through said transparent portion;
iii. a motor disposed within said housing member and operably connected to said display means at a predetermined location thereon for rotating said display means;
iv. a power source operably connected to said motor at a predetermined location thereon for supplying power thereto such that said motor can rotate said display means;
v. a switch means operably connected to said power source for selectively turning said power source on and off;
vi. a control means operably connected to at least one of said display means, such automobile, said power source, said motor, said switch means, and a combination thereof at a predetermined location thereon for enabling a user to select a predetermined side of said display means for rotation such that said predetermined side is at least one of rearward facing and visible through said transparent portion of said housing member;
vii. a stop means operably connected to at least one of said display means, said housing member, and a combination thereof at a predetermined location thereon for selectively stopping said display means from rotating once said selected predetermined side is at least one of rearward facing and visible through said transparent portion of said housing member;
viii. a lighting means operably disposed within at least one of said housing member and said display means at a predetermined location thereon and operably connected to at least one of said power source, said display means, said switch means, said control means and a combination thereof for illuminating said display means;
ix. a signal means operably connected to at least one of said control means, said display means, said housing member the power source, the switch means and a combination thereof at a predetermined location thereon for indicating to said control means that said selected predetermined side of said display means is rearward facing; and
x. a timing means operably connected to at least one of said power source, said lighting means, said control means, said switch means and a combination thereof at a predetermined location thereon for automatically ending said illumination of said display means after a predetermined amount of time has passed;
c. rotating said display means;
d. illuminating said display means;
e. timing said illumination; and
f. de-energizing said lighting means.
